(19) United States
(12) Patent Application Publication
(10) Pub. No.: US 2004/0224745 A1
(43) Pub. Date: Nov. 11, 2004

(54) Slot machine with added player selection

(76) Inventor: Michael P. Bregenzer, Wilmette, IL (US)

Correspondence Address: Michael P. Bregenzer, 622 Washington Avenue, Wilmette, IL, 60091, US

(21) Appl. No.: 10/434,185

(22) Filed: May 9, 2003

(51) Int. Cl. A63F 13/00

(52) U.S. Cl. 463/16

(57) ABSTRACT

An apparatus and method for playing a gaming machine in which the player is told in advance that the indicia displays will reveal a winning combination, and that all the player needs to do is choose the correct subset of indicia displays in order to obtain the winning combination. The player then activates the game, but is not told of the results, until after the player chooses a subset of indicia displays, at which time all of the indicia displays are revealed and the player learns of the outcome.

### BACKGROUND OF THE INVENTION

The present invention relates to gaming machines of the type generally referred to as slot machines or fruit machines, and in particular the invention provides a new way to play such a game to allow the player greater interactivity with the game.

Games of chance have been enjoyed by people for thousands of years and have enjoyed widespread popularity in recent times. Many people enjoy playing a wide variety of games that they have not played before. Playing new games adds to the excitement of this recreational activity particularly when some form of “gaming” is involved. As used herein, the term “gaming” and “gaming devices” are used to indicate that some form of wagering is involved, and that players must make wagers of value, whether actual currency or some equivalent of value, e.g., token or credit.

One popular game of chance that has long been enjoyed by many players is the slot machine. Conventionally, a slot machine is configured for a player to input something of value, e.g., a standard denomination of currency or house token or other representation of currency or credit, and then to permit the player to activate the device which causes a plurality of reels to spin and ultimately stop to display a random combination of some form of indicia, for example, numbers or symbols. If this display contains one of a preselected plurality of winning combinations, the machine releases money into a payout chute or onto a credit meter for the player. For example, if a player initially wagered two coins of a national currency and that player won a high payout, that player may receive fifty coins of the same denomination in return.

Players who regularly play gaming machines quickly tire of particular games and therefore it is necessary for manufacturers of these machines to come up with innovative games or game features that add interest to the games provided on such machines in order to keep the players amused and therefore willing to continue playing the game.

Traditionally, slot machines included three reels. One innovation used to increase player interest was a five reel slot machine. It is now well-known in the art to provide more than just the basic three-reel slot machines.

Another common idea included in many gaming machines is a means to permit players to interact with the gaming machine, for example, bonus or feature games that permit the player to select from a variety of objects in order to win an additional prize. In that regard, U.S. Pat. No. 6,511,375 discloses a gaming device bonus round that contains a plurality of groups each having a plurality of selections that the player can pick and receive an award.

### SUMMARY OF THE INVENTION

The instant invention involves a gaming machine in which the player is allowed additional input beyond just placing a wager. For example, in the case of a slot machine with reels, the player is allowed the opportunity to choose which of the reels displayed by the gaming machine will be used to determine whether the game is a winning game or a losing game. In this manner, the player is given increased involvement in the game, making the game more enjoyable, leading to additional play, and therefore, more profits for the casino. The game described more fully below can be implemented as either a primary game, which is to say the player is allowed to choose which reels to play each time a wager is made, or the game can be implemented as a “bonus” or “feature” game, which is to say, in certain limited instances, perhaps upon a certain reel combination on the primary game, the player is allowed to play an additional round either for free or for an additional wager. In this “bonus” or “feature” round, the player is allowed to choose which reels to play before they are spun to determine whether the chosen combination will reveal a winning result or a losing result. It will be understood that the instant invention can be implemented as a slot machine with mechanical reels, as a slot machine with video reels, as a combination of the two, as a poker-type gaming machine, or virtually any other type of gaming machine known in the art.

### BRIEF DESCRIPTION OF THE DRAWINGS

FIG. 1 is a schematic layout of a typical gaming machine.

FIG. 2 is a drawing illustrating an example of the display portion of a five reel video slot machine in accord with one of the preferred embodiments described herein.

FIG. 3 is a drawing illustrating an example of the display portion of a five reel video slot machine in accord with one of the preferred embodiments described herein.

### DETAILED DESCRIPTION

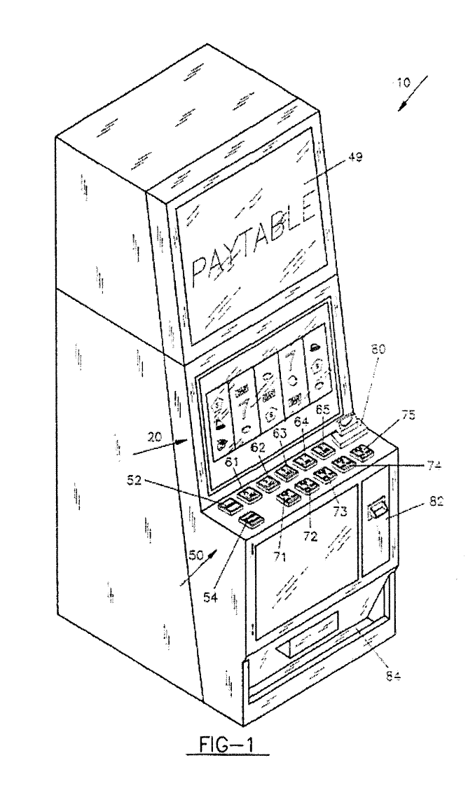

Referring now to FIG. 1, there is shown a five-reel slot machine 10. The indicia of reels 20 are displayed on a video screen in the middle of the gaming machine. For purposes of this patent, the term indicia display, is one of many ways to display the outcome or results from a gaming machine. For example, an indicia display would include cards, indicia of cards, reels, wheels, indicia of reels, indicia of wheels, dice, indicia of dice, or some other indicia. Also, an indicia display can include both a series of displays as well as one display that displays a series of indicia. For example, an indicia display can be one, two or three physical reels from a three reel slot machine, or it can be the depiction of one, two, three, four or five reels from a video five-reel slot machine. An indicia display as that term is used herein does not include a payline. The gaming machine of the instant invention could be one of many different types, including a mechanical slot machine with mechanical reels, a video slot machine wherein the reels are displayed on some sort of screen, such as a video screen or a touch screen, a combination of the two, a poker-type game, or some other type of electronic casino game as are well-known in the art. But for purposes of illustration, here, the gaming machine 10 is a five-reeled video slot machine.

Above the video screen 20 is a paytable 49. In addition to the information usually displayed in a paytable, the paytable, in one of the preferred embodiments advises the player that every spin of the reels will result in a winning combination on some subset of the indicia displays. The player chooses which subset of indicia displays he or she will use, in the embodiment set forth in FIG. 1, by pressing the touchscreen 20. Buttons 61, 62, 63, 64 and 65 permit the player to indicate how many paylines he will wager. The paytable 49 tells the player that in order to have the highest odds of winning, all paylines should be played. For example, the paytable might indicate that somewhere on the five reels, on the nine paylines, there will be a winning combination. Thus, if the player selects the right reels, but does not play the appropriate payline, then the player will not win and receive a payout at the coin tray 84. In order to start the game, a player can insert coins or tokens into coin slot 80 or bill acceptor 82. Notably, in a preferred embodiment, there will also be a card reader for insertion of a player tracking card and/or cashless gaming card. On the gaming machine there will be an area where buttons can be placed 50. For example, in FIG. 1, buttons 71, 72, 73, 74 and 75, permit the player to make a wager. More specifically, button 71 permits the player to bet one coin per payline. Button 72 permits the player to bet two coins per payline, and so on and so forth until button 75, which permits a max bet. Button 54 causes the reels to spin. In the embodiment disclosed by FIG. 1, the player selects the subset of indicia displays to play before spinning the reels. Once the player has finished playing, the player presses button 52 which causes the gaming machine to payout to coin tray 84.

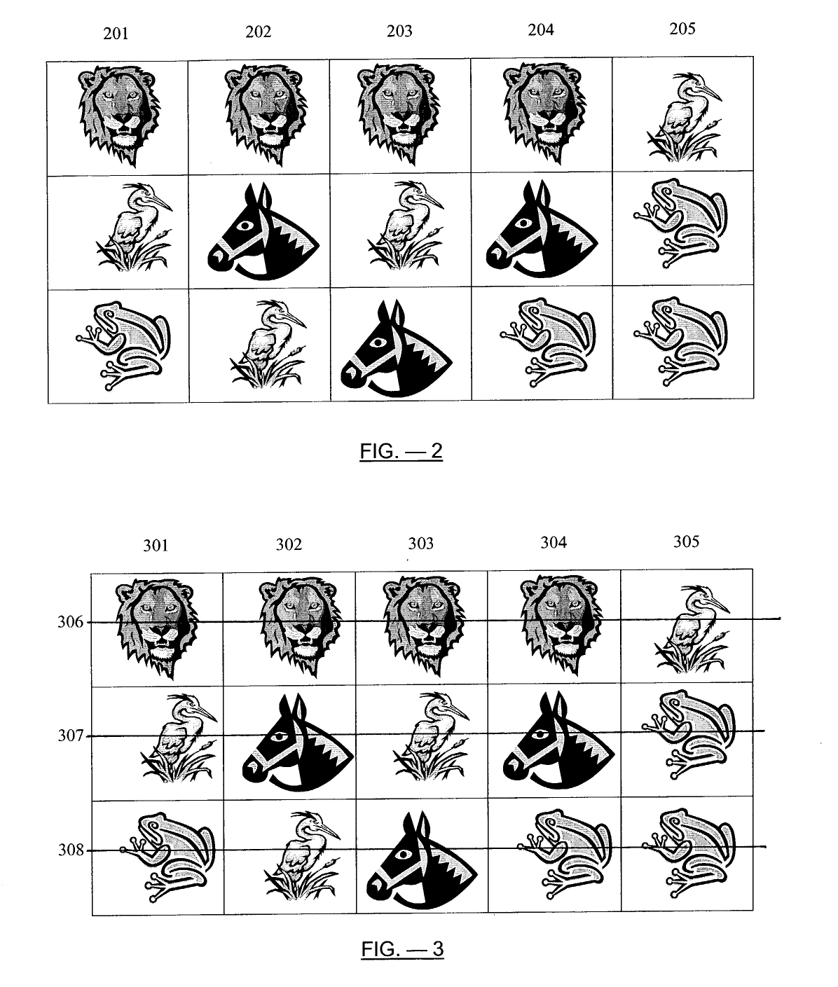

Referring now to FIG. 2, this drawing shows the display portion of a five-reel slot machine. Columns 201, 202, 203, 204, and 205, are each a reel, or an indicia of a reel. Each reel has three spots displayed to the player. Similarly, FIG. 3 also shows the display portion of a five-reel slot machine. Columns 301, 302, 303, 304, and 305, are each a reel. Although more than three paylines can be created from a five-reel display, FIG. 3 shows three paylines, 306, 307, and 308. Payline 306 displays a winning combination of three lions on reels 301, 302, and 303. Thus, if the player had selected reels 301, 302, and 303, and played payline 306, the player would have been a winner. Similarly, if the player had chosen reels 302, 303, and 304, and played payline 306, the player would also have been a winner, matching three lions. But if the player had chosen reels 303, 304, and 305, the player would not have been a winner, even if he payline 306 had been played.

In one of the preferred embodiments, the gaming machine is a five-reeled mechanical slot machine. A display advises the player that every game has at least one winning combination. This display can be a video screen, an LED display, a plasma screen, or even a sticker or other written notice attached to the game. In another embodiment, the player is advised that there will be at least one winning combination displayed by the indicia display. This can be done in any number of ways including sound effects, an LED display, a VFD display, a plasma screen, a video screen, a touch screen, a sticker, words printed or placed on the gaming machine itself, a sign, or some other method of conveying information to a player. Thus, if the player chooses correctly, the player will win on every play. This is a significant advantage to this invention over prior art inventions, in that the player knows that if he or she chooses right, the player will win every time, as opposed to prior art slot machines where the player knows that there will be certain plays that are losing results. While this may seem to be a problem, since the player must necessarily lose money in order for the casino to make money, it is actually not a problem. For example, in the case of a five reel slot machine wherein the player chooses three reels, the player has a just a 60% chance of picking the correct three reels. Thus, while the player has the impression that every spin of the reels is a winner, in actuality, the odds of a player winning is much less. A benefit to this is that a game can have a lower hold (i.e., be more profitable) while still giving the impression that it pays out more frequently than it really does. Once the gaming machine is activated by the player placing a wager, or inserting a player card, or one of the other methods commonly known in the art to activate a gaming machine, the player is given the opportunity to choose three of the five reels to play. This can be done by selection buttons associated with each reel. The player cannot choose more than three reels or less then three reels. Once the player makes the selection, the reels are spun. Using the three reels chosen by the player, the game then determines whether a winning combination is displayed on the three reels chosen by the player. If there was a winning combination, then coins or credits are paid out. It is understood that coins can be paid out either directly, or credits can be added to the credits already on the game. The player is also provided the opportunity to see what the results could have been if the player had chosen a different three reels. For example, the three reels chosen by the player may not reveal a winning combination. But had the player chosen a different set of three reels, the player would have had a winning result. This gives the player the sense that they have a direct impact on the game, thereby increasing player enjoyment.

In another preferred embodiment, the gaming machine is a mechanical slot machine. A display advises the player that every game has at least one winning combination. The player makes a wager and causes the reels to spin. The reels, however, are not visible to the player because they are concealed by some sort of cover. Once the reels stop spinning, the player is prompted to choose some of the reels. For example, the player may choose three of the five reels. Once the reels are chosen by the player, the covers hiding the reels from the player are moved so that the player can see the results. Then, if there was a winning combination, the coins or credits are paid out. The fact that the reels are spun before the player chooses the reels offers some additional assurance to the player that the game is not fixed or rigged in some way; again increasing the player's enjoyment and ultimately the success of the game.

In another preferred embodiment, the gaming machine operates like a standard gaming machine, which is to say that the player makes a wager and the reels spin revealing the results. Then, on a certain specified combination or combinations, the player is allowed to play either a bonus game or a feature game. It will be understood that the bonus or feature game can be triggered either by a combination of indicia, such as three specific indicia, by a single indicia, such as a special symbol, or by some other means, such as the number of games played, the length of time the game has been played, the amount of money wagered, or by some other means. In a bonus game, the player is not required to make an additional wager. In a feature game, the player is required to make an additional wager in order to be allowed to play. But apart from that distinction, the game is essentially the same, which is to say the player is prompted to choose certain of the indicia displays, again, these could be reels, wheels, cards, or dice, some other indicia display as discussed above. All of the indicia displays are activated, meaning the indicia displayed on the indicia display are revealed. For example, the reels or wheels could be spun to reveal the result, or the cards could be turned over to reveal them, or the dice could be rolled. Alternatively, if the indicia displays had already been activated, but obscured from the player's vision, the means for obscuring could be removed. In this context, means for obscuring could be a piece of hardware, such as a cover over the reels, or it could be a piece of software that acts via a processor to control the video screen to display another image, including no image, instead of the results. The player can then see whether or not they chose a set of indicia displays that displayed a winning combination.

In another preferred embodiment, the gaming machine is a five-reeled video slot machine. It will be understood that while five reels is preferred, the game can be instituted on any number of reels. A display advises the player that every game has at least one winning combination. Once the gaming machine is activated by the player placing a wager, or inserting a player card, or one of the other methods commonly known in the art to activate a gaming machine, the player is given the opportunity to choose three of the five reels to play. This can be done by selection buttons associated with each reel, or a touch screen. The player selects the required number of reels, usually less than the total number of reels. Once the player makes the selection, the reels are spun. Using the reels chosen by the player, the game then determines whether a winning combination is displayed. If there was a winning combination, then coins or credits are paid out. It is understood that coins can be paid out either directly, or credits can be added to the credits already on the game. The player is also provided the opportunity to see what the results could have been if the player had chosen a different three reels. For example, the reels chosen by the player may not reveal a winning combination, but had the player chosen a different set of three reels, the player would have had a winning result. Thus the game could notify the player that he or she did not choose reels that revealed a winning combination, but had the player chosen an alternate group of reels, the player would have won “x” number of coins. This gives the player the sense that they have a direct impact on the game, thereby increasing player enjoyment. It also gives the player a sense that if they had played better, they would have won. It also gives the player a sense that there is a lot of money to be won, even if they are not winning it, there is still the possibility to win on every turn.

In another preferred embodiment, the gaming machine is a five-reeled video slot machine. It will be understood that while five reels is preferred, the game can be instituted on any number of reels. A display advises the player that every game has at least one winning combination. Once the gaming machine is activated by the player placing a wager, or inserting a player card, or one of the other methods commonly known in the art to activate a gaming machine, the reels spin. The results of the reels are not immediately displayed to the player. Rather, they are obscured or not shown to the player. The player is then prompted to choose some subset of the reels. This can be done by selecting buttons associated with each reel, or pressing a touch screen, or some other selection means known in the art. Once the player makes the selection, the results of the reel spin is revealed to the player. Using the reels chosen by the player, the game then determines whether a winning combination is displayed. If there was a winning combination, then coins or credits are paid out. It is understood that coins can be paid out either directly, or credits can be added to the credits already on the game. The player is also provided the opportunity to see what the results could have been if the player had chosen a different subset of reels. For example, the reels chosen by the player may not reveal a winning combination, but had the player chosen a different set of three reels, the player would have had a winning result. Thus the game could notify the player that he or she did not choose reels that revealed a winning combination, but had the player chosen an alternate group of reels, the player would have won “x” number of coins. This can be done by first highlighting the results of the reels chosen by the player, so as to illustrate those results. Then, the winning combinations can be highlighted showing the player what could have been. Alternatively, this can be done simultaneously using different colors.

In another embodiment, not only is the player told that there is at least one winning combination, the player is specifically told what types of potential winning combinations there are for that particular game. For example, assuming the player has spun the reels before selecting the reels to play, the game can determine that using all five reels, there are winning combinations resulting in a payout of two coins, five coins, and 100 coins. Thus, the player knows that there is a chance for a significant win. This also increases the anticipation associated with the game, leading to more exciting play. Then, if the player chooses a set of reels that only pays out two coins, the player will be encouraged to keep playing in the hopes that he or she will choose the better payout next time. It will be understood that this portion of the invention can be implemented just as easy on any other type of indicia display device. For example, the player can be told in a card game that depending on his or her choice of poker hands or cards, there is a five of a kind that can be won, or two pair, or some other winning combination. Again, this increases the anticipation associated with the game leading to more play, and therefore more profits for the casino.

In another preferred embodiment, the gaming machine is a poker-type gaming machine. For example, the game could be a five card draw type poker game. The player is dealt some number of cards more than five face down. The player then chooses which of the cards will be incorporated into his or her hand. All of the cards are then displayed so the player can see what cards are in his or her hand, and also, so the player can see what cards could have been, but are not included in his or her hand. Then, the game can proceed like normal five card draw, which is to say the player can choose to keep a certain number of cards, or discard a certain number of cards, and obtain replacements. Once the player either receives the new cards or chooses to stand pat, the game determines whether it is a winning hand, and makes the appropriate payouts. Again, this could be either a direct payout of coins, or could simply be adding credits to the credit meter or a player card.

Alternatively, the gaming machine is a poker-type gaming machine. For example, the game could be a five card draw type poker game. The player is dealt some number of cards more than five face down. The player then chooses which of the cards will be incorporated into his or her hand. All of the cards are then displayed so the player can see what cards are in his or her hand, and also, so the player can see what cards could have been, but are not included in his or her hand. Notably, this conceivably gives the player an edge in the game. For example, if the player's initial hand was 2, 3, 4, and 5 of hearts, and the six of hearts is among the cards now showing but not in his hand, the player knows he cannot get a straight flush. Thus, if the player's fifth card was a 6 of diamonds, the player will likely stand pat rather than risk going for the straight flush. Then, the player is offered the opportunity to replace certain cards in his or her hand. For example, the player decides to keep two cards and discard three. The player is then offered the opportunity to choose the three replacement cards from a total of five offered by the game. These cards are displayed face down. Again, once the player selects the three cards that are going to be added to his or her hand, all five of the cards are flipped over to (a) tell the player what cards will constitute his or her hand, and (b) tell the player what could have been had the player chosen differently.

In another preferred embodiment, the gaming machine is a poker-type gaming machine. For example, the game could be a five card draw type poker game. In this instance, the player is dealt some number of hands. The player then chooses which of the hands will be the hand he plays. Once the player makes his or her selection, all of the hands are displayed to let the player know what the cards are in the hand he or she is playing, as well as the hands that he or she could have been playing had the player chosen differently. Then, the game can proceed like normal five card draw, which is to say the player can choose to keep a certain number of cards, or discard a certain number of cards, and obtain replacements. If the player chooses to discard some of the cards and obtain others, the player can be allowed to simply get replacement cards, or, can be offered a number of cards, displayed face down, to choose from. Once a final hand is made, the player is either paid accordingly or offered the chance to play another game.

It should be understood that this game is equally applicable to a seven card stud game, blackjack, or some other form of poker. In essence, the player picks his cards instead of having the dealer provide the cards off the top of the deck.

In the instant invention, it will also be understood that this game can be implemented in such a way that it is not a payout associated with a winning combination, but some other type of win. For example, the player could be awarded a multiplier as a result of obtaining a winning combination or a winning hand. For example, depending on the winning combination a multiplier of 1×, 2×, 3× and so on can be awarded. In this instance, the player obtains a winning result in the base or standard game. The player is then allowed to play a bonus or feature game. If the player obtains a certain result in that game, then a multiplier is awarded. In this instance, the game will operate exactly as described above except that a multiplier is awarded instead of cash or credits. This multiplier is then used to multiply either the last game result, the next game's result, or the player could save the multiplier until some later game wherein the base game payout was larger. Or, the payout could be of the double-or-nothing sort, which is to say, if the player picks right, the payout is multiplied by two, and if the player picks wrong, the player loses the initial wager. It will be understood that for purposes of the multiplier embodiment, there are many things that could be multiplied. For example, the payout from the base game could be multiplied, the initial wager could be multiplied, the amount bet per line could be multiplied, or portions of each could be multiplied. Alternatively, the payout could be something tangible like a new car or something intangible like a vacation or a free night in the casino's hotel.

In another part of this invention, the player is offered a choice of paylines. While many games today permit the player to select, for example, 1, 3, 5 or 9 paylines, in the instant invention, the player is permitted to select certain payline and is prohibited from selecting others. For example, the player is told he or she can select 7 out of 9 paylines. If the player attempts to select 8 or 9 paylines, this will not be permitted. From this point, the game is similar to as described above. The player is told that at least one of the paylines will have a winning result. The player selects the subset of paylines to play, and the reels spin. The player then learns whether he or she chose the correct payline. Alternatively, as described above, the reels can spin, but the results not be revealed until after the player selects the appropriate paylines to play.

The present invention can also be used on a gaming machine that includes progressive functionality. Gaming systems that include progressive systems are known in the art. In a progressive system, machines are linked together so that, in addition to the normal games played on the gaming machines, players can compete for an additional prize. In a progressive game, each coin played on a progressive game terminal contributes a percentage of its denominational value to the prize amount, and in this way the prize amount may increase at a rate related to the percentage factor and player participation. One type of progressive gaming system is described, for example, in U.S. Pat. No. 4,837,728. Another type is described, for example, in U.S. Pat. No. 5,885,158. Those disclosures are incorporated herein.

The present invention can also be used on a gaming machine that includes cashless functionality. Cashless functionality, in general, eliminates the need for bill acceptors, coin handling equipment and printers at various game terminals of a casino or other gaming establishments. In one embodiment of a cashless system, and it will be understood that there are many different embodiments, instead of a player playing with change, coin, chips or other credit items, the player hands over a certain amount of money to a clerk. The clerk provides that player with a player card that either contains a variety of information or permits access to a variety of information stored in a database, including the credits stored on the card, as well as various information about the player such as his or her name, address, and other information to allow the casino to effectively track the player and market to the player. The player card can then be used at gaming machines, or table games, in lieu of change, coin, chips or other credit items. In addition, the player card can be used simply for player tracking. At a gaming machine, for example, the player card is read by the game terminal card reader of a selected game terminal, whereupon the cash amount on the card, which is stored at a central database, is downloaded or accessed by the gaming machine and displayed to the player on the selected game terminal. Operation of that gaming machine by the player can then begin. The player continues to play the selected gaming machine long as desired or as long as a cash amount remains on the gaming machine. If the player wishes to play a different game terminal, the player actuates a cashout switch on the gaming machine currently being played. The gaming machine uploads the cash amount balance to the data base. The player can then move to a different gaming machine. The player card is read by the new gaming machine, whereupon the cash amount balance at the data base is downloaded or accessed and displayed to the player on the new gaming machine. The player can then play the new gaming machine. Finally, when the player wishes to stop play completely, the player again pushes the cashout switch. The gaming machine transfers the cash amount balance to the data base. The player then takes his player card to a clerk and the clerk reads the card to obtain the identification information and the cash amount balance therefrom. The player is paid the cash amount on the spot.

In terms of the mechanics of implementing the instant invention, it will be well understood by one skilled in the art how to implement this instant invention using a processor or processors to control the gaming machine. It will also be well understood that the software and firmware that controls the game is stored on various memory devices, such as a ROM, EPROM, EEPROM, flash memory, hard drive, disk drive, or other alterable or inalterable memory or memories, and that the memory devices are linked to the processor or processors. More specifically, a slot machine of the type disclosed herein could take many forms. One such form is a microprocessor based system that includes both hardware and software components to provide the game playing capabilities. The hardware components include a display for displaying the game play, this display could be either mechanical or some form of video display, mechanical or electro-mechanical switches, electronic switches, or a touch screen for enabling player selection of the indicia displays and for other game play choices, coin acceptors and detectors, bill acceptors and detectors, card acceptors and detectors, as well as the electronic components usually found in a microprocessor based system, such as random access memory (RAM), read only memory (ROM), a processor or processors, in some cases, a hard drive or other alterable memory, and one or more busses. In addition, the gaming machine will include a number of player controls, such as buttons, arms, switches, touch screens, knobs, and the like to allow the player to make certain inputs into the game. The software components include the initialization software, credit and payout routines, the game image and rules data set, and a random number generator algorithm. It should be understood that this invention can, and in a preferred embodiment will, include “virtual reel” technology as disclosed in U.S. Pat. No. 4,448,419, the disclosure of which is hereby incorporated by reference.

The instant invention can be instituted on any indicia selection game. Its essence is that the player gets to choose which indicia to play without knowing which indicia will display a winning combination. Also, the player gets to see what could have been if he or she had made a different choice.

It will be understood that the foregoing sets forth certain different combinations in which the instant invention can be set-up. It will be understood that the foregoing combinations are representative, and not limited just to those combinations.

What is claimed is:

1. A method of playing a game on a gaming machine, the method comprising the following steps:
placing a wager;
activating the game;
using a plurality of indicia displays to provide a plurality of randomly selected indicia, but not immediately displaying the plurality of randomly selected indicia to the player;
permitting the player to select a subset of indicia displays from said plurality of indicia displays;
displaying said plurality of randomly selected indicia to the player;
awarding the player a payout in the event of a winning combination displayed by said selected subset of indicia displays.

2. The method of claim 1, with the additional step of the player being notified in advance that a winning combination will be displayed.

3. The method of claim 1, with the additional step that the player is notified in advance of at least one specific winning combination that will be displayed.

4. The method of claim 1, with the additional step of inserting a player card.

5. The method of claim 1 in which the steps are not performed in the same order as set forth in claim 1.

6. The method of claim 1 in which the gaming machine is configured for cashless operation.

7. The method of claim 1 in which the gaming machine is configured for progressive operation.

8. The method of claim 1, in which the indicia displays are cards.

9. The method of claim 1 in which the player chooses the subset of indicia displays before the plurality of indicia displays display randomly selected indicia.

10. A method of playing a casino game, the method comprising the following steps:
generating a plurality of randomly selected indicia;
selecting a subset of indicia displays from a set of indicia displays;
displaying a plurality of randomly selected indicia;
awarding the player a payout in the event of a winning combination.

11. The method of claim 10, in which the plurality of randomly selected indicia are obscured from the view of the player until after the player selects a subset of indicia displays from a set of indicia displays.

12. The method of claim 10 in which the player is informed that every game includes a winning combination.

13. The method of claim 10, in which the casino game is not played until after a certain, specified result on a primary casino game.

14. The method of claim 10, in which the steps are not performed in the specific order set forth in claim 10.

15. The method of claim 10, in which the steps are repeated more than once.

16. The method of claim 10, in which the indicia displays constitute cards.

17. A method of playing an electronic slot machine, the method comprising the following steps:
placing a wager;
providing the player with a plurality of paylines;
requiring the player to select a subset of paylines from said plurality of paylines;
prohibiting the player from selecting all the paylines;
activating said machine;
generating a plurality of randomly selected indicia;
displaying a plurality of randomly selected indicia;
awarding the player a payout in the event of a winning combination on one of the paylines chosen by the player.
